(19) United States
(12) Patent Application Publication
(10) Pub. No.: US 2020/0094723 A1
(43) Pub. Date: Mar. 26, 2020

(54) AUXILIARY CUP HOLDER AND CUP HOLDER ASSEMBLY FOR CAR

(71) Applicant: Zhejiang Geely Holding Group Co., LTD., Hangzhou City, Zhejiang Province (CN)

(72) Inventor: SHUFU LI, Hangzhou City, Zhejiang Province (CN)

(21) Appl. No.: 16/615,792

(22) PCT Filed: Dec. 7, 2018
(86) PCT No.: PCT/CN2018/119928

§ 371 Date: Nov. 21, 2019

(30) Foreign Application Priority Data
Dec. 25, 2017 (CN) 201711421966.2

(51) Int. Cl. B60N 3/10

(52) U.S. Cl. CPC B60N 3/103

(57) ABSTRACT

An auxiliary cup holder and a cup holder assembly are provided. The auxiliary cup holder includes a first cup body and a second cup body. The second cup body is connected to a top end of the first cup body. An inner diameter of the second cup body is greater than an outer diameter of the first cup body or an inner diameter of the second cup body is adjustable. The first cup body is adapted for being placed and fixed in a cup holding groove as provided originally in a car. The second cup body is configured for placing drinking containers.

### CROSS-REFERENCE TO RELATED APPLICATION

The present application is based on and claims the priority of Chinese patent application No. 201711421966.2, filed on Dec. 25, 2017. The entire disclosure of the above-identified application is incorporated herein by reference.

### TECHNICAL FIELD

The present application relates to accessories for cars, and particularly to an auxiliary cup holder and a cup holder assembly for a car.

### BACKGROUND ART

With the popularity of cars, consumers have put forward higher requirements for the functions of car accessories. The accessories of cars should not only meet people's basic daily needs, but also should meet the needs of convenient operations and less space occupation. Cup holder is an important accessory provided on the car, used to place water cups or other beverage containers and solving the problem of placing drinking containers on the car for the consumers.

Nowadays, the cup holders in the cars are generally designed on the instrument panel or in the storage box between the main driver and the deputy driver, some are bare receptacles, some are retractable cup holders that can be hidden in the storage box or by the armrest. However, the existing cup holder has a fixed aperture size and is only suitable for placing cups with specific size. When the outer diameter of the cup is too large, the cup can not be placed in the cup holder. When the outer diameter of the cup is too small, the cup will shake in the cup holder, and the liquid in the cup can be easily spilled out.

### Technical Solution

In view of the above, it is necessary to provide an auxiliary cup holder and a cup holder assembly for a car, which can be used to place drinking containers with different sizes.

The present application provides an auxiliary cup holder. The auxiliary cup holder includes a first cup body and a second cup body. The second cup body is connected to a top end of the first cup body. An inner diameter of the second cup body is greater than an outer diameter of the first cup body or an inner diameter of the second cup body is adjustable. The first cup body is adapted for being placed and fixed in a cup holding groove as provided originally in a car. The second cup body is configured for placing drinking containers.

According to one embodiment, the auxiliary cup holder further includes a third cup body. The third cup body is connected to a top end of the second cup body. An inner diameter of the third cup body is greater than an inner diameter of the second cup body. The third cup body is configured for placing drinking containers.

According to one embodiment, the second cup body is moveably connected to the first cup body, and the second cup body is moveable along a height direction of the first cup body.

According to one embodiment, sliding rails and sliding grooves are provided on the first cup body and the second cup body, and the sliding rails are engaged in the sliding grooves. The second cup body is capable of sliding up and down relative to the first cup body.

According to one embodiment, protrusions are provided on an outer surface of the first cup body, and indentations are provided on the second cup body correspondingly. When the second cup body is stretched up relative to the first cup body, the protrusions are engaged in the indentations for maintaining the second cup body in place.

According to one embodiment, mutually engaged threads are provided on the first cup body and the second cup body, and the first cup body and the second cup body are threadedly engaged with each other.

According to one embodiment, the first cup body includes a first airbag, the second cup body includes a second airbag, the first airbag is provided with a first nozzle for air charging and discharging, and the second airbag is provided with a second nozzle for air charging and discharging. The first airbag functions as a sidewall for the first cup body after the first airbag is charged with air. The second airbag functions as a sidewall for the second cup body after the second airbag is charged with air.

According to one embodiment, the first cup body and the second cup body are each a corrugated pipe.

According to one embodiment, the second cup body includes a first clamping arm and a second clamping arm, and at least one of the first clamping arm and the second clamping arm is moveable to alter a distance between the first clamping arm and the second clamping arm, whereby the inner diameter of the second cup body is adjusted.

According to one embodiment, the second cup body further includes a substrate. The substrate is connected to the first cup body. The first clamping arm and the second clamping arm are connected to the substrate.

According to one embodiment, each of the first clamping arm and the second clamping arm is slideable relative to the substrate. The first clamping arm is connected with a first sliding portion and the first sliding portion is slideably connected to the substrate. The second clamping arm is connected with a second sliding portion and the second sliding portion is slideably connected to the substrate.

According to one embodiment, sliding grooves are provided in the substrate. The first sliding portion and the second sliding portion are received and slideable correspondingly in the sliding grooves.

The present application further provides a cup holder assembly. The cup holder assembly includes an original cup holder as originally provided in a car and an auxiliary cup holder as mentioned above. The original cup holder is provided with a cup holding groove. An inner diameter of the cup holding groove corresponds to an outer diameter of the first cup body of the auxiliary cup holder. The first cup body of the auxiliary cup holder is adapted for being placed and fixed in the cup holding groove. The second cup body of the auxiliary cup holder is configured for placing drinking containers.

According to one embodiment, the original cup holder includes a cup holding part, a support part and a torsion spring, the cup holding groove is provided in the cup holding part, the support part is rotatably connected with the cup holding part, a support plate is provided at a distal end of the support part, two ends of the torsion spring connect respectively with the cup holding part and the support part.

According to one embodiment, the cup holding groove of the original cup holder is directly defined around a storage box or an armrest of the car.

### Advantageous Effects

When the outer diameter of a drinking container does not match with the inner diameter of a cup holding groove originally provided on a car and the drinking container can not be placed directly in the cup holding groove, the auxiliary cup holder provided by the present application can be used, the first cup body of the auxiliary cup holder is placed and fixed in the cup holding groove, and then the drinking container is placed in the second cup body of the auxiliary cup holder, so that drinking containers with different sizes can be well placed by using the auxiliary cup holder provided by the present application.

### DESCRIPTION OF DRAWINGS

FIG. 1 is an isometric view of an auxiliary cup holder according to a first embodiment of the present application.

FIG. 2 is a cross-sectional view of the cup holder of FIG. 1.

FIG. 3 is a cross-sectional view of an auxiliary cup holder according to a second embodiment of the present application.

FIG. 4a is a cross-sectional view of an auxiliary cup holder according to a third embodiment of the present application.

FIG. 4b shows the auxiliary cup holder of FIG. 4a after it is retracted.

FIG. 5a is a cross-sectional view of an auxiliary cup holder according to a fourth embodiment of the present application.

FIG. 5b shows the auxiliary cup holder of FIG. 5a after it is retracted.

FIG. 6a is a cross-sectional view of an auxiliary cup holder according to a fifth embodiment of the present application.

FIG. 6b shows the auxiliary cup holder of FIG. 6a after it is retracted.

FIG. 7a is a cross-sectional view of an auxiliary cup holder according to a sixth embodiment of the present application.

FIG. 7b shows the auxiliary cup holder of FIG. 7a after it is retracted.

FIG. 8a is an isometric view of an auxiliary cup holder according to a seventh embodiment of the present application.

FIG. 8b is another isometric view of the auxiliary cup holder of FIG. 8a.

FIG. 9 is an isometric view of a cup holder assembly according to a specific embodiment of the present application.

### MODE FOR INVENTION

In order to make the purposes, characteristics, and advantages of the present application more apparently, embodiments of the present application will now be described in more detail with reference to the accompanying drawings.

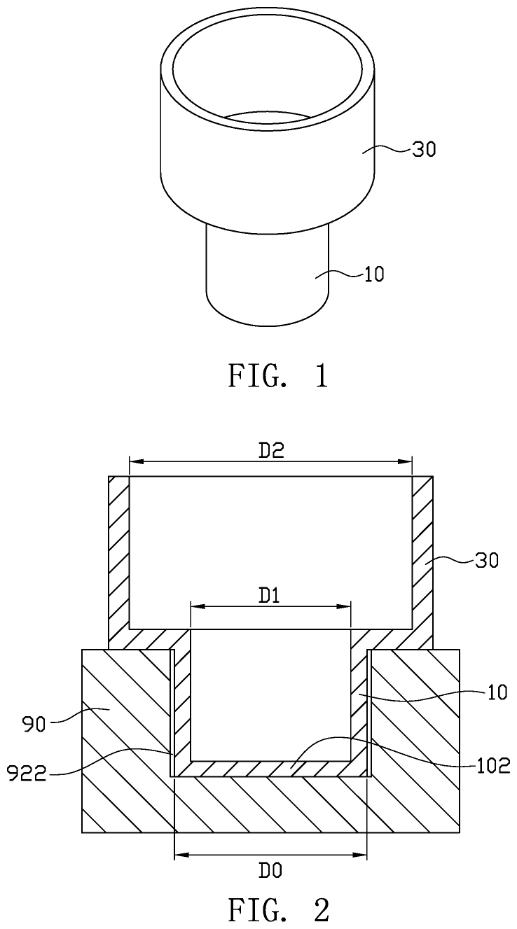

Referring to FIG. 1 and FIG. 2, an auxiliary cup holder provided according to a first embodiment of the present application includes a first cup body 10 and a second cup body 30. The second cup body 30 is fixedly connected to a top end of the first cup body 10. The first cup body 10 and the second cup body 30 are disposed coaxially. The first cup body 10 has an outer diameter D0 and an inner diameter D1, while the second cup body 30 has an inner diameter D2. The inner diameter D2 of the second cup body 30 is greater than the outer diameter D0 of the first cup body 10. Since the first cup body 10 has a wall thickness, the inner diameter D1 of the first cup body 10 will be smaller than its outer diameter D0.

In a car, an original cup holder 90 is generally provided for placing drinking containers (such as cups, beverage bottles, etc) for the consumers. The original cup holder 90 is provided with a cup holding groove 922. When an outer diameter of the drinking container is equal to an inner diameter of the cup holding groove 922, the drinking container can be placed directly in the cup holding groove 922.

However, when the outer diameter of the drinking container is larger than the inner diameter of the cup holding groove 922, the drinking container can not be placed directly in the cup holding groove 922. In such case, the auxiliary cup holder can be placed in the cup holding groove 922, as shown in FIG. 2. The first cup body 10 is placed and fixed in the cup holding groove 922, and the drinking container can be placed in the second cup body 30 which has an inner diameter D2 larger than the inner diameter of the cup holding groove 922.

On the other hand, when the outer diameter of the drinking container is smaller than the inner diameter of the cup holding groove 922, the drinking container may easily shake if it is placed directly in the cup holding groove 922. In such case, the auxiliary cup holder can be placed in the cup holding groove 922, as shown in FIG. 2. The first cup body 10 is placed and fixed in the cup holding groove 922, and the drinking container can be placed in the first cup body 10 which has an inner diameter D1 smaller than the inner diameter of the cup holding groove 922, to avoid the problem that the drinking container may easily shake if it is directly placed in the cup holding groove 922. As a result, drinking containers with different sizes can be well placed by using the auxiliary cup holder.

In this embodiment, the first cup body 10 has an outer diameter D0 equaling to the inner diameter of the cup holding groove 922 which is provided originally in the car, so that the first cup body 10 can be fittingly inserted into and fixed in the cup holding groove 922. The first cup body 10 has an inner diameter D1 smaller than the inner diameter of the cup holding groove 922, such that the drinking container with small outer diameter can be placed in the first cup body 10. The second cup body 30 has an inner diameter D2 larger than the inner diameter of the cup holding groove 922, such that the drinking container with large outer diameter can be placed in the second cup body 30.

In this embodiment, the first cup body 10 and the second cup body 30 each have a shape of cylinder, two ends of the second cup body 30 are opened, a top end of the first cup body 10 connecting with the second cup body 30 is opened, and a bottom end of the first cup body 10 is sealed.

In this embodiment, the bottom end of the first cup body 10 is provided with a bottom plate 102, and the bottom plate 102 seals the bottom end of the first cup body 10. In other embodiments, the bottom end of the first cup body 10 may also be opened, in that case the bottom plate 102 may be omitted.

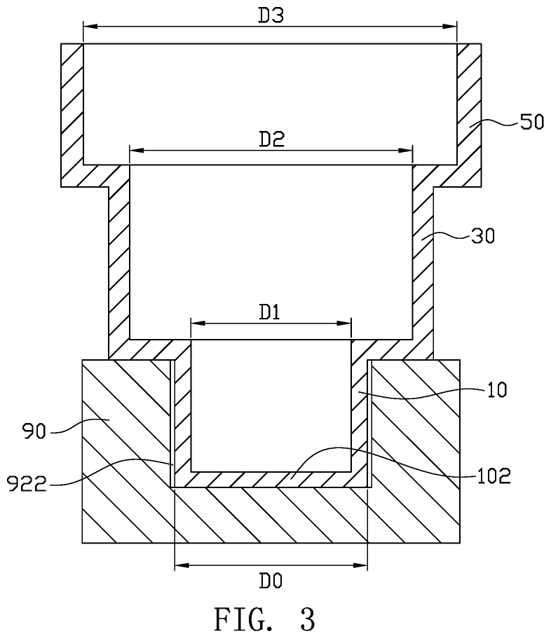

Referring to FIG. 3, an auxiliary cup holder provided according to a second embodiment of the present application includes a first cup body 10, a second cup body 30 and a third cup body 50. The second cup body 30 is fixedly connected to a top end of the first cup body 10, and the third cup body 50 is fixedly connected to a top end of the second cup body 30. The first cup body 10, the second cup body 30 and the third cup body 50 are disposed coaxially. An inner diameter D2 of the second cup body 30 is greater than an outer diameter D0 of the first cup body 10, and an inner diameter D3 of the third cup body 50 is greater than an inner diameter D2 of the second cup body 30.

By using the auxiliary cup holder of this embodiment, drinking containers with more different sizes can be easily placed. As shown in FIG. 3, the first cup body 10 is inserted into and fixed in the cup holding groove 922 which is provided originally in the car. The drinking containers with small size can be placed in the first cup body 10, the drinking containers with medium size can be placed in the second cup body 30, and the drinking containers with large size can be placed in the third cup body 50.

In this embodiment, the first cup body 10 has an outer diameter D0 equaling to the inner diameter of the cup holding groove 922 which is originally provided in the car, so that the first cup body 10 can be fittingly inserted into and fixed in the cup holding groove 922. The first cup body 10 has an inner diameter D1 smaller than the inner diameter of the cup holding groove 922, such that the drinking container with a small-size outer diameter can be placed in the first cup body 10. The second cup body 30 has an inner diameter D2 larger than the inner diameter of the cup holding groove 922, such that the drinking container with a medium-size outer diameter can be placed in the second cup body 30. The third cup body 50 has an inner diameter D3 larger than the inner diameter D2 of the second cup body 30, such that the drinking container with a large-size outer diameter can be placed in the third cup body 50.

In this embodiment, the first cup body 10, the second cup body 30 and the third cup body 50 each have a shape of cylinder, two ends of each of the second cup body 30 and the third cup body 50 are opened, a top end of the first cup body 10 connecting with the second cup body 30 is opened, and a bottom end of the first cup body 10 is sealed.

In this embodiment, the bottom end of the first cup body 10 is provided with a bottom plate 102, and the bottom plate 102 seals the bottom end of the first cup body 10. In other embodiments, the bottom end of the first cup body 10 may also be opened, in that case the bottom plate 102 may be omitted.

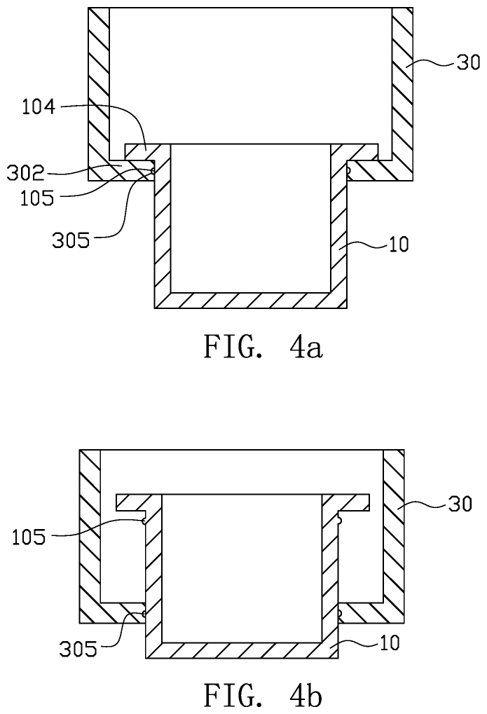

Referring to FIG. 4a and FIG. 4b, an auxiliary cup holder provided according to a third embodiment of the present application includes a first cup body 10 and a second cup body 30. The first cup body 10 and the second cup body 30 are disposed coaxially. The second cup body 30 is moveably connected to the first cup body 10, and the second cup body 30 is moveable along a height direction of the first cup body 10. An inner diameter D2 of the second cup body 30 is greater than an outer diameter D0 of the first cup body 10.

In this embodiment, sliding rails and sliding grooves may be provided on the first cup body 10 and the second cup body 30, for example, sliding rails are provided on the first cup body 10, and sliding grooves are provided on the second cup body 30, or vice versa. The sliding rails are engaged in the sliding grooves, so that the second cup body 30 can slide up and down relative to the first cup body 10. When the auxiliary cup holder is not in use, it can be retracted to be reduced in size for being stored in the storage box of the car, as shown in FIG. 4b.

In this embodiment, protrusions 105 are provided on an outer surface of the first cup body 10, indentations 305 are provided on the second cup body 30 correspondingly. When the second cup body 30 is stretched up relative to the first cup body 10, the protrusions 105 are engaged in the indentations 305 for maintaining the second cup body 30 in place, as shown in FIG. 4a.

Specifically, a connecting part 302 is provided at the bottom end of the second cup body 30, and the indentations 305 are provided in an inner surface of the connecting part 302. A flange 104 is provided at the top end of the first cup body 10, and when the second cup body 30 is stretched up, the connecting part 302 abuts against the flange 104 to prevent the second cup body 30 from disengaging with the first cup body 10. Specifically, in this embodiment, the connecting part 302 extends radially inwardly from the bottom end of the second cup body 30, and the flange 104 extends radially outwardly from the top end of the first cup body 10.

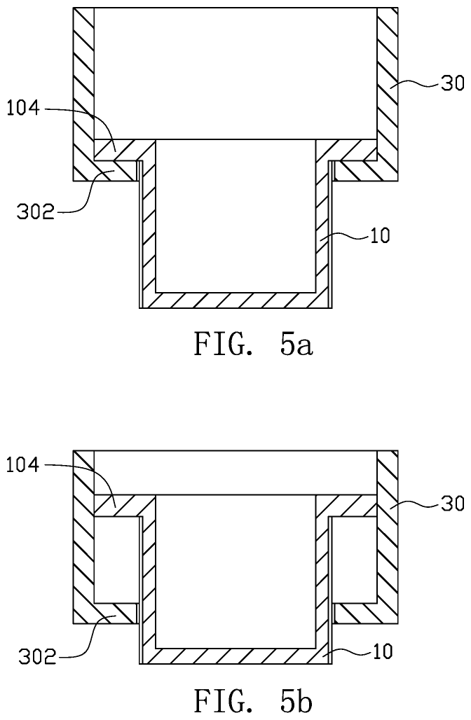

Referring to FIG. 5a and FIG. 5b, an auxiliary cup holder provided according to a fourth embodiment of the present application includes a first cup body 10 and a second cup body 30. The first cup body 10 and the second cup body 30 are disposed coaxially. The second cup body 30 is moveably connected to the first cup body 10, and the second cup body 30 is moveable along a height direction of the first cup body 10. An inner diameter D2 of the second cup body 30 is greater than an outer diameter D0 of the first cup body 10.

In this embodiment, mutually engaged threads are provided on the first cup body 10 and the second cup body 30. The first cup body 10 and the second cup body 30 are threadedly engaged with each other by threads, so that the second cup body 30 is stretchable and retractable relative to the first cup body 10.

In this embodiment, an outer thread is provided on an outer surface of the first cup body 10, a connecting part 302 is provided at the bottom end of the second cup body 30, and an inner thread engageable with the outer thread is provided on an inner surface of the connecting part 302. When the second cup body 30 is rotated, the second cup body 30 is retracted or stretched relative to the first cup body 10. When the auxiliary cup holder is not in use, it can be retracted to be reduced in size for being stored in the storage box of the car, as shown in FIG. 5b.

Specifically, a flange 104 is provided at the top end of the first cup body 10, and when the second cup body 30 is stretched up, the connecting part 302 abuts against the flange 104 to prevent the second cup body 30 from disengaging with the first cup body 10. In this embodiment, the connecting part 302 extends radially inwardly from the bottom end of the second cup body 30, and the flange 104 extends radially outwardly from the top end of the first cup body 10.

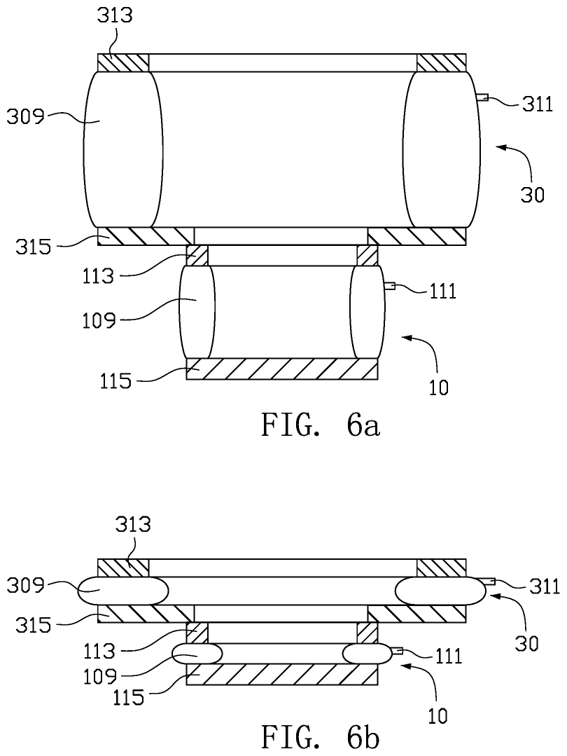

Referring to FIG. 6a and FIG. 6b, an auxiliary cup holder provided according to a fifth embodiment of the present application includes a first cup body 10 and a second cup body 30. The second cup body 30 is connected to a top end of the first cup body 10. The first cup body 10 and the second cup body 30 are disposed coaxially. An inner diameter D2 of the second cup body 30 is greater than an outer diameter D0 of the first cup body 10. The first cup body 10 is provided with a first airbag 109, and the second cup body 30 is provided with a second airbag 309. The first airbag 109 is provided with a first nozzle 111 for air charging and discharging, and the second airbag 309 is provided with a second nozzle 311 for air charging and discharging. The first airbag 109 functions as a sidewall for the first cup body 10 after the first airbag 109 is charged with air, and the second airbag 309 functions as a sidewall for the second cup body 30 after the second airbag 309 is charged with air.

In this embodiment, the first cup body 10 and the second cup body 30 are respectively provided with the inflatable first airbag 109 and the inflatable second airbag 309. When the auxiliary cup holder needs to be used, the first airbag 109 and the second airbag 309 can be inflated by blowing the first nozzle 111 and the second nozzle 311 with mouth, until the air bags 109, 309 are expanded into a cup shape, as shown in FIG. 6a. When the auxiliary cup holder is not in use, the first airbag 109 and the second airbag 309 are deflated, so that the auxiliary cup holder is reduced in size for being stored in the storage box of the car, as shown in FIG. 6b.

In this embodiment, the first cup body 10 further includes a first end ring 113 and a first end plate 115 which are connected respectively to two ends of the first airbag 109. the second cup body 30 further includes a second end ring 313 and a second end plate 315 which are connected respectively to two ends of the second airbag 309. The first end ring 113, the second end ring 313 and the second end plate 315 each have an annular shape, and the first end plate 115 is annular or plate-shaped. The first end ring 113, the first end plate 115, the second end ring 313 and the second end plate 315 can provide support for the first airbag 109 and the second airbag 309.

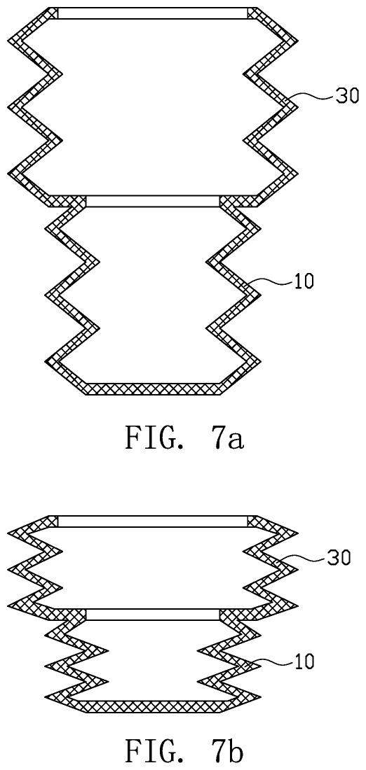

Referring to FIG. 7a and FIG. 7b, an auxiliary cup holder provided according to a sixth embodiment of the present application includes a first cup body 10 and a second cup body 30. The second cup body 30 is connected to a top end of the first cup body 10. The first cup body 10 and the second cup body 30 are disposed coaxially. An inner diameter D2 of the second cup body 30 is greater than an outer diameter D0 of the first cup body 10. The first cup body 10 and the second cup body 30 are each a corrugated pipe. By choosing proper material and thickness, the corrugated pipe has a certain rigidity and still can be compressed and deformed.

In this embodiment, the first cup body 10 and the second cup body 30 are compressible corrugated pipes. When the auxiliary cup holder needs to be used, the first cup body 10 and the second cup body 30 can be stretched to the state as shown in FIG. 7a. When the auxiliary cup holder is not in use, the first cup body 10 and the second cup body 30 can be compressed to the state as shown in FIG. 7b, so that the auxiliary cup holder can be stored conveniently in the storage box of the car.

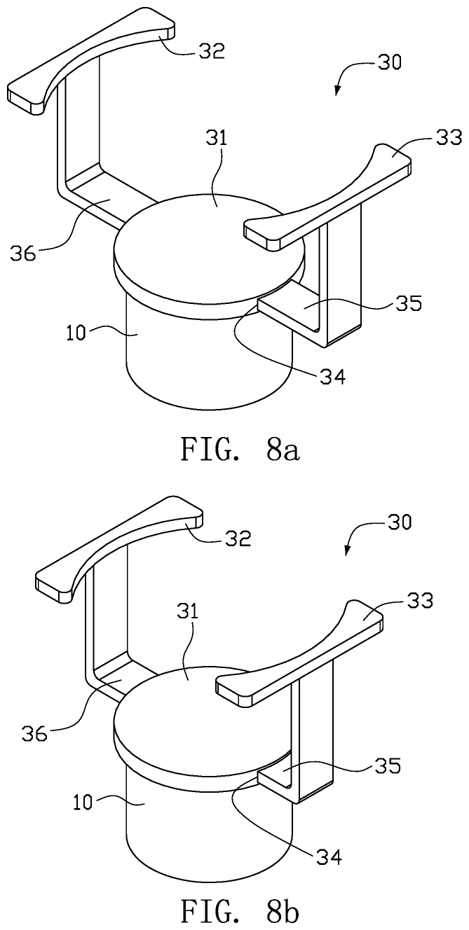

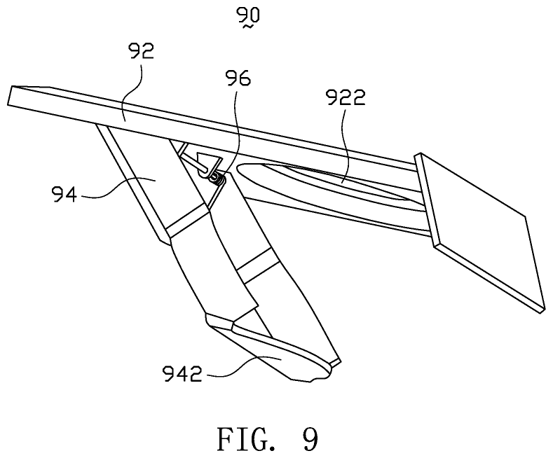

Referring to FIG. 8a and FIG. 8b, an auxiliary cup holder provided according to a seventh embodiment of the present application includes a first cup body 10 and a second cup body 30. The second cup body 30 includes a substrate 31, a first clamping arm 32 and a second clamping arm 33. The substrate 31 is connected to the first cup body 10. The first clamping arm 32 and the second clamping arm 33 are connected to the substrate 31. At least one of the first clamping arm 32 and the second clamping arm 33 is moveable relative to the substrate 31 to alter a distance between the first clamping arm 32 and the second clamping arm 33, so that an inner diameter D2 of the second cup body 30 is adjusted. That is, the inner diameter D2 of the second cup body 30 is adjustable.

In this embodiment, when the auxiliary cup holder needs to be used, the drinking container is placed in the second cup body 30, the substrate 31 provides support to the drinking container. Then, the first clamping arm 32 and/or the second clamping arm 33 is adjusted according to the size of the drinking container, such that the inner diameter D2 of the second cup body 30 is adjusted to match with the drinking container and the drinking container is clamped together by the first clamping arm 32 and the second clamping arm 33.

In this embodiment, it is preferred that each of the first clamping arm 32 and the second clamping arm 33 can slide relative to the substrate 31. For example, the first clamping arm 32 is connected with a first sliding portion 36, the first sliding portion 36 extends radially inwardly from a bottom end of the first clamping arm 32, and the first sliding portion 36 is slideably connected to the substrate 31. The second clamping arm 33 is connected with a second sliding portion 35, the second sliding portion 35 extends radially inwardly from a bottom end of the second clamping arm 33, and the second sliding portion 35 is slideably connected to the substrate 31. Specifically, sliding grooves 34 are provided in the substrate 31, the first sliding portion 36 and the second sliding portion 35 are received and slideable correspondingly in the grooves 34.

When the drinking container has a large outer diameter, the first clamping arm 32 and the second clamping arm 33 are extended out relative to the substrate 31 to increase the distance between the first clamping arm 32 and the second clamping arm 33, in order to clamp the drinking container with large outer diameter, as shown in FIG. 8a. When the drinking container has a small outer diameter, the first clamping arm 32 and the second clamping arm 33 are retracted back relative to the substrate 31 decrease the distance between the first clamping arm 32 and the second clamping arm 33, in order to clamp the drinking container with small outer diameter, as shown in FIG. 8b.

Preferably, an inner side of each of the first clamping arm 32 and the second clamping arm 33 is arc-shaped, which is helpful to closely abut against the outer surface of the drinking container when the drinking container is clamped by the two clamping arms 32, 33, to thereby hold the drinking container firmly.

Referring to FIG. 9, a cup holder assembly according to a specific embodiment the present application includes an original cup holder 90 and the above-mentioned auxiliary cup holder. The original cup holder 90 includes a cup holding part 92, and the cup holding part 92 is provided with a cup holding groove 922. The inner diameter of the cup holding groove 922 corresponds to the outer diameter D0 of the first cup body 10 of the auxiliary cup holder, so that the first cup body 10 can be placed and fixed in the cup holding groove 922.

In this embodiment, the original cup holder 90 is of the pull-push type. When the original cup holder 90 needs to be used, it is pulled out, for example, from the instrument panel of the car. When the original cup holder 90 is not in use, it is pushed back into the instrument panel to hide it inside the car. The original cup holder 90 may further include a support part 94. The support part 94 is rotatably connected with the cup holding part 92, and a support plate 942 is provided at a distal end of the support part 94 for supporting the bottom end of a drinking container or the bottom end of the first cup body 10 of the auxiliary cup holder. The support plate 942 is aligned with the cup holding groove 922. Further, the original cup holder 90 may include a torsion spring 96, and two ends of the torsion spring 96 connect respectively with the cup holding part 92 and the support part 94, such that the support part 94 rotates automatically with respect to the cup holding part 92 to the state as shown in FIG. 9 as the original cup holder 90 is pulled out from the instrument panel of the car.

In other embodiments, the original cup holder 90 may have different structure. For example, the original cup holder 90 may be formed directly by defining the cup holding groove 922 around the storage box or the armrest of the car, as shown in FIG. 2 and FIG. 3.

The above are embodiments of the present application only, and should not be deemed as limitations to the present application. Although the present application has been disclosed in embodiments as above, it is not intended to limit the present application. It should be noted that variations and improvements will become apparent to those skilled in the art to which the present application pertains. Therefore, the scope of the present application is defined by the appended claims.

### INDUSTRIAL APPLICABILITY

When the outer diameter of a drinking container does not match with the inner diameter of a cup holding groove originally provided on a car and the drinking container cannot be placed directly in the cup holding groove, the auxiliary cup holder provided by the present application can be used, the first cup body of the auxiliary cup holder is placed and fixed in the cup holding groove, and then the drinking container is placed in the second cup body of the auxiliary cup holder, so that drinking containers with different sizes can be well placed by using the auxiliary cup holder provided by the present application.

1. An auxiliary cup holder, comprising a first cup body and a second cup body, wherein the second cup body is connected to a top end of the first cup body, an inner diameter of the second cup body is greater than an outer diameter of the first cup body or an inner diameter of the second cup body is adjustable, the first cup body is adapted for being placed and fixed in a cup holding groove as provided originally in a car, the second cup body is configured for placing drinking containers.

2. The auxiliary cup holder of claim 1, wherein the auxiliary cup holder further comprises a third cup body, the third cup body is connected to a top end of the second cup body, an inner diameter of the third cup body is greater than an inner diameter of the second cup body, the third cup body is configured for placing drinking containers.

3. The auxiliary cup holder of claim 1, wherein the second cup body is moveably connected to the first cup body, the second cup body is moveable along a height direction of the first cup body.

4. The auxiliary cup holder of claim 3, wherein sliding rails and sliding grooves are provided on the first cup body and the second cup body, the sliding rails are engaged in the sliding grooves, the second cup body is capable of sliding up and down relative to the first cup body.

5. The auxiliary cup holder of claim 3, wherein protrusions are provided on an outer surface of the first cup body, indentations are provided on the second cup body correspondingly, when the second cup body is stretched up relative to the first cup body, the protrusions are engaged in the indentations for maintaining the second cup body in place.

6. The auxiliary cup holder of claim 3, wherein mutually engaged threads are provided on the first cup body and the second cup body, the first cup body and the second cup body are threadedly engaged with each other.

7. The auxiliary cup holder of claim 1, wherein the first cup body comprises a first airbag, the second cup body comprises a second airbag, the first airbag is provided with a first nozzle for air charging and discharging, the second airbag is provided with a second nozzle for air charging and discharging, the first airbag functions as a sidewall for the first cup body after the first airbag is charged with air, the second airbag functions as a sidewall for the second cup body after the second airbag is charged with air.

8. The auxiliary cup holder of claim 1, wherein the first cup body and the second cup body are each a corrugated pipe.

9. The auxiliary cup holder of claim 1, wherein the second cup body comprises a first clamping arm and a second clamping arm, at least one of the first clamping arm and the second clamping arm is moveable to alter a distance between the first clamping arm and the second clamping arm, whereby the inner diameter of the second cup body is adjusted.

10. The auxiliary cup holder of claim 9, wherein the second cup body further comprises a substrate, the substrate is connected to the first cup body, the first clamping arm and the second clamping arm are connected to the substrate.

11. The auxiliary cup holder of claim 10, wherein each of the first clamping arm and the second clamping arm is slideable relative to the substrate, the first clamping arm is connected with a first sliding portion and the first sliding portion is slideably connected to the substrate, the second clamping arm is connected with a second sliding portion and the second sliding portion is slideably connected to the substrate.

12. The auxiliary cup holder of claim 11, wherein sliding grooves are provided in the substrate, the first sliding portion and the second sliding portion are received and slideable correspondingly in the sliding grooves.

13. A cup holder assembly, comprising an original cup holder as originally provided in a car and an auxiliary cup holder of claim 1, wherein the original cup holder is provided with a cup holding groove, an inner diameter of the cup holding groove corresponds to an outer diameter of the first cup body of the auxiliary cup holder, the first cup body of the auxiliary cup holder is adapted for being placed and fixed in the cup holding groove, the second cup body of the auxiliary cup holder is configured for placing drinking containers.

14. The cup holder assembly of claim 13, wherein the original cup holder includes a cup holding part, a support part and a torsion spring, the cup holding groove is provided in the cup holding part, the support part is rotatably connected with the cup holding part, a support plate is provided at a distal end of the support part, two ends of the torsion spring connect respectively with the cup holding part and the support part.

15. The cup holder assembly of claim 13, wherein the cup holding groove of the original cup holder is directly defined around a storage box or an armrest of the car.
